(19) United States
(12) Patent Application Publication
(10) Pub. No.: US 2004/0070759 A1
(43) Pub. Date: Apr. 15, 2004

(54) Vector representation of polarization dependent loss

(76) Inventor: Duwayne R. Anderson, St. Helens, OR (US)

Correspondence Address: Francis I. Gray, TEKTRONIX, INC., MS 50-LAW, P.O. BOX 500, Beaverton, OR, 97077, US

(21) Appl. No.: 10/271,273

(22) Filed: Oct. 14, 2002

(51) Int. Cl. G01N 21/21

(52) U.S. Cl. 356/364

(57) ABSTRACT

A vector representation of polarization dependent loss (PDL) is introduced so that the true PDL of a composite optical system having more than one optical component in combination may be measured using a Mueller Matrix method. An optical source having four input states of polarization is measured at each polarization state to generate the first row of values for the Mueller Matrix for the optical source alone derived from the transmission coefficients. The first row of values is converted into a PDL vector for the optical source alone. The output of the composite optical system having the optical source as input is measured at each polarization state to generate the first row of values for a Mueller Matrix for the composite optical system including the optical source. The first row of values is converted into a PDL vector for the composite optical system in combination with the optical source. The absolute value of the PDL for the composite optical system is determined as the absolute value of the vector difference between the two PDL vectors. By representing the PDL of each optical component in an optical system as a vector, the behavior of the optical system may be approximately predicted by the vector combination of the individual PDL vectors.

### BACKGROUND OF THE INVENTION

The present invention relates to the measurement of optical characteristics of devices, and more particularly to a method of measuring polarization dependent loss using a vector representation.

Polarization dependent loss (PDL) affects optical systems in several ways, one of which is to cause fluctuations in received optical power when the state of polarization wanders. For example swept laser systems have become the method of choice for measuring the transmission/reflection characteristics of optical components and subsystems, the device under test (DUT). In addition such systems may also characterize the wavelength-dependent loss (PDL) and polarization mode dispersion (PMD) of the DUT.

One technique for measuring PDL, known as the all-states method (ASM), involves injecting light with a wide variety of states of polarization into the DUT and measuring the transmitted optical power. The equipment scans the state of polarization over a large sample of random states, measuring the transmitted power at each state, and calculates the PDL from the following equation:

PDL=10*log{Powerₘₐₓ/Powerₘᵢₙ} (1)

This treats PDL as a scalar quantity and provides no information about the loss at a particular state of polarization.

Another technique for measuring PDL is called the Mueller Matrix method (MMM), disclosed in U.S. Pat. No. 5,371,597 issued Dec. 6, 1994 to David L. Favin et al entitled “System and Method for Measuring Polarization Dependent Loss.” This approach measures the transmitted power through the DUT at four precisely determined states of polarization. From these transmission data it is possible to calculate the top row of a Mueller Matrix (Table 1) from which it is then possible to determine PDL according to Equation (2). Like the ASM, the MMM treats PDL as a scalar.

PDL=10*log[(m_{0,0}+α)/(m_{0,0}−α)] (2)

where α=SQRT(m_{0,1}²+m_{0,2}²+m_{0,3}²).

TABLE 1

| | Transmission | Component of |
|---|---|---|
| State of polarization | coefficient | Mueller matrix |
| Linear horizontal | T0 | m_{0, 0 = (T0 + T1)/2} |
| Linear vertical | T1 | m_{0, 1 = (T0 - T1)/2} |
| Linear diagonal | T2 | m_{0, 2 = T2 - m}_{0 ,0} |
| Right-hand circular | T3 | m_{0 3 = T3 - m}_{0, 0} |

Using the MMM works well for measuring the PDL of each individual optical component. However, treating PDL as a scalar quantity makes it impossible to properly add the PDL from different optical components to achieve the composite PDL of several components that make up an optical system. For example, although both linear polarizers shown in FIG. 1 have a PDL of 0.5 dB, the scalar sum of 1.0 dB produces an erroneous result because the total PDL is actually 0 dB. In other words, the MMM does a good job of measuring the PDL of multiple components, but cannot measure the scalar PDL of different components and then add them to get the total PDL for an optical system. It is possible to derive the combined PDL of several components, but only by knowing all sixteen elements of the full Mueller Matrix for each component.

N. Gisin (“Statistics of Polarization Dependent Losses”, Optics Communications 114 (1995) 399-405) recognized that the global attenuation for multiple optical elements is generally not the sum of the attenuation of each of the elements, but rather is a quantity that depends on the relative orientation of the different elements. He proposed a simple measurement of PDL and the analysis of the combination of two PDL elements in an optical link. He uses vectors to represent polarization states on a Poincare sphere, where the magnitude of the PDL equals the length of the vector. The vector relates simply to the Stokes parameters Sⱼ, S=(S₁, S₂, S₃) so that M=S/S₀, where M is a vector, the length of which represents the degree of polarization. The corresponding PDL is defined as a vector ┌ parallel to Mₘₐₓ. The PDL for two elements ┌_{1,2} is a complicated expression of the two individual PDL vectors ┌₁ and ┌₂.

What is desired is a simple method for measuring PDL that is accurate when optical components are coupled together to form an optical system.

### BRIEF SUMMARY OF THE INVENTION

Accordingly the present invention provides a method of measuring polarization dependent loss (PDL) for a composite optical system using a vector representation together with a Mueller Matrix method. An optical source having four input states of polarization is measured at each polarization state to generate the first row of values in the Mueller Matrix. The first row of values is converted into a PDL vector for the optical source alone. The output of the composite optical system having the optical source as input is measured at each polarization state to generate another first row of values in the Mueller Matrix. This first row of values is converted into a PDL vector for the combination of the composite optical system and the optical source. The absolute value of the PDL for the composite optical system is determined as the absolute value of the vector difference between the PDL for the optical source alone and the PDL for the combination of the composite optical system and the optical source.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is an illustrative view indicating that PDL is not a scalar quantity.

FIG. 2 is a block diagram view of a test system for measuring PDL according to the present invention.

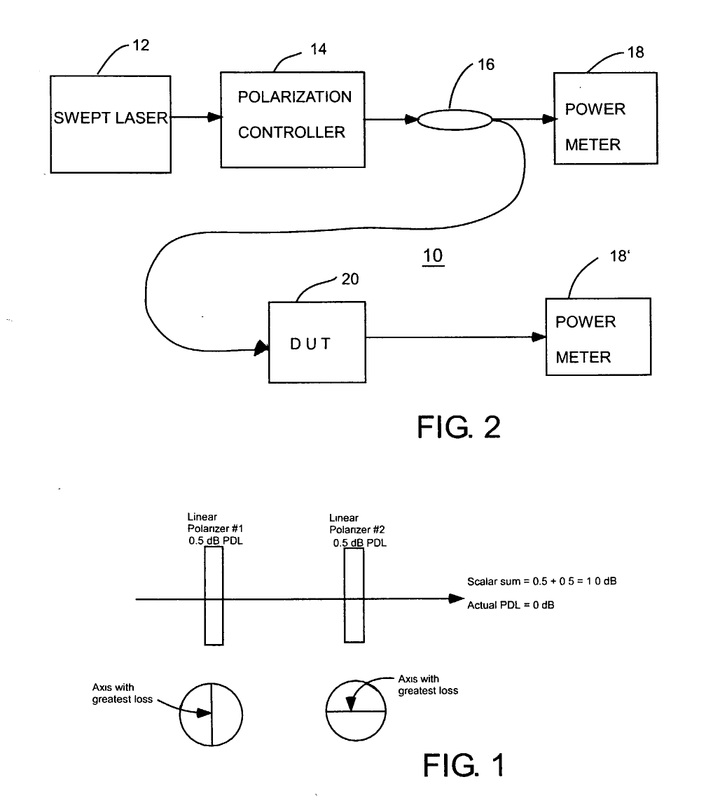

### DETAILED DESCRIPTION OF THE INVENTION

Fundamental to the present method is the acquisition of four scans of optical power data at each of a plurality of measurement wavelengths, one at each of four different input states of polarization, and the subsequent construction of a vector representation of the PDL at each wavelength. This approach lends itself to relatively easy implementation, since a polarization controller needs to switch only at a scan-repetition rate which is on the order of a second or two. The primary issue is accurate calibration of transmission coefficients, as the Mueller Matrix method (MMM) is very sensitive to accurate determination of such coefficients. FIG. 2 illustrates a test system 10 for the present method. A swept laser 12 provides an optical source. A polarization controller 14 selects one of the four different optical states of polarization for the optical source 12. The selected polarization state of the optical source 12 is applied via a coupler 16 either directly to a power meter 18 or to a device under test (DUT) 20. The output of the DUT is input to another (or the same) power meter 18′.

The measurement method acquires four successive scans without the DUT 20 in place at each of a plurality of measurement wavelengths. Each of these scans uses one of the four input states of polarization required by the MMM. Likewise four successive scans are acquired with the DUT 20 placed in the test system, again one at each of the four input states of polarization. From these data the method calculates an effective PDL vector for each wavelength, both with and without the DUT 20 in the test system. The absolute value of the PDL of the DUT at each wavelength in the scan is given approximately by

|PDL_{λ(i)}|=|VECTOR(PDL_{before(i)})−VECTOR(PDL_{after(i)})| (3)

VECTOR(PDL_{before(i)}) is the PDL vector at the i^{th} wavelength derived from the four scans acquired before placing the DUT 20 into the test system, while VECTOR(PDL_{after(i)}) is the PDL vector at the i^{th} wavelength derived from the four scans with the DUT in the test system. The PDL vector is defined as:

VECTOR(PDL)=10log[(m_{0,0}+α)/(m_{0,0}−α)]*[(m_{0,1}/α), (m_{0,2}/α),(m_{0,3}/α)] (4)

In this representation the length of the PDL vector equals the PDL in dB and the vector points in the direction of the state of polarization with the greatest loss.

The utility of the PDL vector comes from its predictive behavior in understanding the composite PDL of systems made from different optical components. For example two components with linear dichroism, serially aligned, have a composite PDL given approximately by:

VECTOR(PDL₁)+VECTOR(PDL₂)=VECTOR(PDL_{1,2}) (5)

Equation (5), although like equation (3) is not exact, is an excellent approximation when the PDL is less than a few dB, and it lends itself to a simplified view that provides insight for unique test and measurement applications.

Even for the more general case of elliptical dichroism, the following useful equation holds with good accuracy:

|VECTOR(PDL₂)|=|VECTOR(PDL_{1,2})−VECTOR(PDL₁)| (6)

The vector representation of PDL has several advantages, among which are simplified calibration methods for test equipment used to measure PDL. It also provides a new qualitative method of viewing PDL and predicting behavior.

In summary, using the coordinate system of the Poincare Sphere, the PDL vector has its tail at the origin, points in the direction of the state of polarization having the greatest loss, and has length equal to the PDL in dB of the optical component. By vectorially combining the PDL vectors for each optical component in an optical system, the behavior of the optical system may be approximately predicted.

Thus the present invention provides a method of measuring PDL using a vector representation by filling the first row of a Mueller Matrix with values derived from four specific polarization states to generate a pair of PDL vectors at each measurement wavelength, first without and then with an optical DUT in the system, and then by determining the PDL for the DUT at each wavelength as the absolute value of the vector difference between the two PDL vectors.

What is claimed is:

1. A method of measuring polarization dependent loss (PDL) for a composite optical system having an optical source and an optical device comprising the steps of:
acquiring four successive scans from the optical source at each of four input states of polarization for a particular measurement wavelength to generate a first PDL vector;
acquiring four successive scans from the composite optical system at each of the four input states of polarization for the particular measurement wavelenght to generate a second PDL vector; and
obtaining from the first and second PDL vectors the PDL for the composite optical system.

2. The method as recited in claim 1 wherein the acquiring steps each comprise the steps of:
extracting from the successive scans respective transmission coefficients;
computing from the transmission coefficients values for the first row of a Mueller Matrix; and
calculating the PDL vector as
VECTOR(PDL)=10* log [(m_{0,0}+α)/(m_{0,0}−α)]*[(m_{0,1}/α),(m_{0,2}/α), (m_{0,3}/α)]
where m_{0,0}, m_{0,1}, m_{0,2} and m_{0,3} are the values for the first row of the Mueller Matrix and α=SQRT(m_{0,1}²+m_{0,2}²+m_{0,3}²).

3. The method as recited in claim 1 wherein the obtaining step comprises the step of deriving the absolute value of the vector difference between the first and second PDL vectors as the PDL for the composite optical system.

4. A method of approximately predicting a behavior for a composite optical system having a plurality of optical components comprising the steps of:
obtaining a vector representation of PDL for each optical component in the composite optical system; and
vectorially combining the vector representations of PDL to predict the behavior for the composite optical system.
